(19) United States
(12) Patent Application Publication
(10) Pub. No.: US 2025/0337141 A1
(43) Pub. Date: Oct. 30, 2025

(54) NONAQUEOUS ELECTROLYTE SECONDARY BATTERY

(71) Applicant: Prime Planet Energy & Solutions, Inc., Tokyo (JP)

(72) Inventor: Ryu YAMASHITA, Himeji-shi (JP)

(21) Appl. No.: 19/186,621

(22) Filed: Apr. 23, 2025

(30) Foreign Application Priority Data
Apr. 26, 2024 (JP) 2024-072013

(51) Int. Cl. H01M 50/593; H01M 10/0525; H01M 10/0567; H01M 50/103; H01M 50/119

(52) U.S. Cl. CPC H01M 50/593; H01M 10/0525; H01M 10/0567; H01M 50/103; H01M 50/119

(57) ABSTRACT

A nonaqueous electrolyte secondary battery in which a problem in a conventional art is solved is provided. The nonaqueous electrolyte secondary battery disclosed herein includes an electrode body, a nonaqueous electrolyte solution, an electrode terminal, and a battery case that accommodates the electrode body and the nonaqueous electrolyte solution. The battery case is made of aluminum or an aluminum alloy. The battery case includes an exterior can that includes an opening part, and a sealing plate that seals the opening part. The electrode terminal is insulated from the sealing plate by an insulating resin member. The insulating resin member contains polyphenylene sulfide and a glass filler. The insulating resin member exists at least partially inside the battery case and at a position that can be in contact with the nonaqueous electrolyte solution. The nonaqueous electrolyte solution contains a dehydrating agent as an additive.

### CROSS-REFERENCE TO RELATED APPLICATIONS

This application claims the benefit of priority to Japanese Patent Application No. 2024-072013 filed on Apr. 26, 2024. The entire contents of this application are incorporated herein by reference.

### BACKGROUND

The present disclosure relates to a nonaqueous electrolyte secondary battery.

In recent years, a nonaqueous electrolyte solution secondary battery such as a lithium ion secondary battery has been used suitably for a portable power source for a personal computer, a mobile terminal, or the like, a power source for driving a vehicle such as a battery electric vehicle (BEV), a hybrid electric vehicle (HEV), or a plug-in hybrid electric vehicle (PHEV), or the like.

In a nonaqueous electrolyte secondary battery in a typical mode, an electrode body and a nonaqueous electrolyte solution are accommodated in a battery case. The battery case is made of aluminum, and includes an exterior can having an opening part, and a sealing plate that closes the opening part. To the sealing plate, an electrode terminal is attached. Between the sealing plate and the electrode terminal, an insulating resin member is disposed. In order to obtain a structure in which the insulating resin member is disposed between the sealing plate and the electrode terminal, a technique of integrating the sealing plate and the electrode terminal through a resin material by insert molding has been developed (for example, see WO 2020/110888). As the resin material used for the insulating resin member, polyphenylene sulfide (PPS) has been known (for example, see WO 2020/110888 and Japanese Patent Application Publication No. 2011-187401).

### SUMMARY

As a result of earnest examination, the present inventor has found out the following problem. Specifically, in the case of forming the insulating resin member by insert molding using PPS between the sealing plate and the electrode terminal, a molding defect may occur. As a result of the present inventor's examination, this molding defect can be reduced by mixing a glass filler in PPS. In the case of mixing a glass filler in PPS, however, corrosion of the glass filler included in the insulating resin member occurs in the nonaqueous electrolyte secondary battery, which results in deterioration of the insulating resin member.

In view of this, the present disclosure provides a nonaqueous electrolyte secondary battery in which the problem in the conventional art is solved.

A nonaqueous electrolyte secondary battery disclosed herein includes an electrode body, a nonaqueous electrolyte solution, an electrode terminal, and a battery case that accommodates the electrode body and the nonaqueous electrolyte solution. The battery case is made of aluminum or an aluminum alloy. The battery case includes an exterior can that includes an opening part, and a sealing plate that seals the opening part. The electrode terminal is insulated from the sealing plate by an insulating resin member. The insulating resin member contains polyphenylene sulfide and a glass filler. The insulating resin member exists at least partially inside the battery case and at a position that can be in contact with the nonaqueous electrolyte solution. The nonaqueous electrolyte solution contains a dehydrating agent as an additive.

With such a structure, a secondary battery in which the problem in the conventional art is solved can be provided. That is to say, with such a structure, the molding defect occurs less easily in the insert molding of the insulating resin member using PPS. In addition, in the nonaqueous electrolyte secondary battery, the corrosion of the glass filler included in the insulating resin member occurs less easily. Accordingly, the deterioration of the insulating resin member is suppressed.

### BRIEF DESCRIPTION OF THE DRAWINGS

FIG. 1 is a partial cross-sectional view of a battery 10 corresponding to one example of a nonaqueous electrolyte secondary battery according to this embodiment;

FIG. 2 is a partial cross-sectional view illustrating a part of the battery illustrated in FIG. 1, in which an internal terminal 42 and an external terminal 43 are attached to a battery case 41;

FIG. 3 is a partial cross-sectional view of a battery 10A according to another embodiment;

FIG. 4 is a partial cross-sectional view of a battery 10B according to yet another embodiment;

FIG. 5 is a partial cross-sectional view of a battery 10C according to still yet another embodiment;

FIG. 6 is a perspective view for describing a manufacturing method for an electrode terminal structure of the battery 10A; and

FIG. 7 is a perspective view for describing the manufacturing method for the electrode terminal structure of the battery 10A.

### DETAILED DESCRIPTION

Embodiments of the present disclosure will hereinafter be described with reference to the drawings. Matters that are not mentioned in the present specification and that are necessary for the implementation of the present disclosure can be grasped as design matters of those skilled in the art based on the prior art in the relevant field. The present disclosure can be implemented on the basis of the contents disclosed in the present specification and common technical knowledge in the relevant field. It should be noted that in the drawings below, the members and parts with the same operation are explained by being denoted by the same reference sign. In addition, the size relation (length, width, thickness, etc.) in each drawing does not necessarily reflect the actual size relation. Moreover, in the present specification, the numerical range expressed as “A to B” includes A and B.

It should be noted that the term “secondary battery” in this specification refers to an electrical energy storage device capable of being charged and discharged repeatedly. It should be noted that, in the present specification, the term “lithium ion secondary battery” refers to a secondary battery that uses lithium ions as a charge carrier and can be charged and discharged by transfer of charges accompanying with the lithium ions between positive and negative electrodes.

### <<Battery 10>>

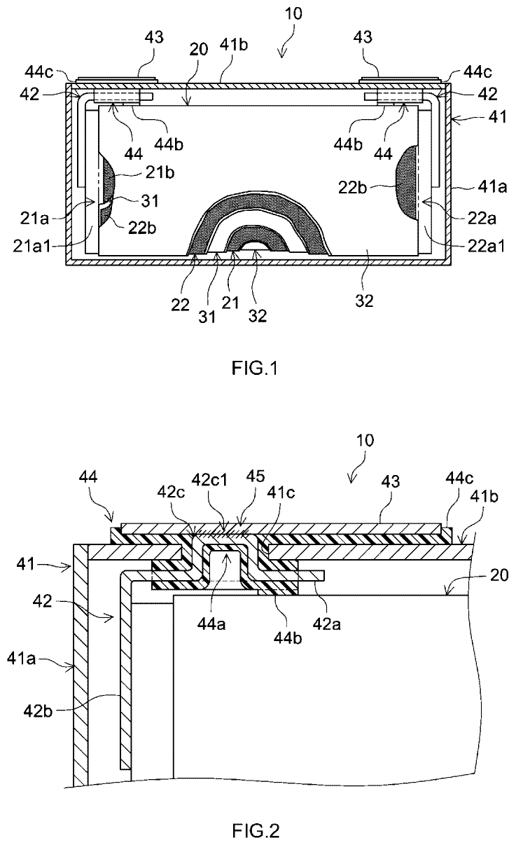

FIG. 1 is a partial cross-sectional view of a battery 10 corresponding to one example of a nonaqueous electrolyte secondary battery according to this embodiment. In this example, the battery 10 is a lithium ion secondary battery. However, the nonaqueous electrolyte secondary battery disclosed herein may be a nonaqueous electrolyte secondary battery other than the lithium ion secondary battery.

In a state illustrated in FIG. 1, the inside is exposed along a wide surface on one side of a battery case 41 with a substantially rectangular cuboid shape. FIG. 2 is a partial cross-sectional view illustrating a part in which an internal terminal 42 and an external terminal 43 are attached to the battery case 41. The battery 10 illustrated in FIG. 1 and FIG. 2 is a so-called sealed battery. The battery 10 includes an electrode body 20, a nonaqueous electrolyte solution (not illustrated), electrode terminals, and the battery case 41 that accommodates the electrode body 20 and the nonaqueous electrolyte solution. In this example, the electrode terminals include the internal terminals 42 and the external terminals 43. The battery 10 also includes an insulating resin member 44.

### <Electrode Body 20>

The electrode body 20 is accommodated in the battery case 41 while being covered with an insulating film (not illustrated) or the like. The electrode body 20 includes a positive electrode sheet 21 as a positive electrode element, a negative electrode sheet 22 as a negative electrode element, and separator sheets 31 and 32 as separators. Each of the positive electrode sheet 21, the first separator sheet 31, the negative electrode sheet 22, and the second separator sheet 32 is a long band-shaped member.

The positive electrode sheet 21 may have a known structure. In this embodiment, in the positive electrode sheet 21, a positive electrode active material layer 21b is formed on one surface or both surfaces (here, both surfaces) of a positive electrode current collection foil 21a. In addition, the positive electrode sheet 21 includes an active material layer non-formation part 21al that is set to have a certain width at an end part on one side in a width direction. The positive electrode current collection foil 21a is, for example, an aluminum foil. The positive electrode active material layer 21b contains a positive electrode active material, which is a material that can release lithium ions at charging and absorb lithium ions at discharging. The positive electrode active material is, for example, lithium transition metal composite oxide, a lithium transition metal phosphate compound, or the like. The positive electrode active material layer 21b may further contain a conductive material (for example, carbon black or the like), a binder (for example, polyvinylidene fluoride or the like), or the like.

The negative electrode sheet 22 may have a known structure. In this embodiment, in the negative electrode sheet 22, a negative electrode active material layer 22b is formed on one surface or both surfaces (here, both surfaces) of a negative electrode current collection foil 22a. In addition, the negative electrode sheet 22 includes an active material layer non-formation part 22a1 that is set to have a certain width at an end part on one side in the width direction. The negative electrode current collection foil 22a is, for example, a copper foil. The negative electrode active material layer 22b contains a negative electrode active material, which is a material that can store lithium ions at charging and release the lithium ions, which are stored at the charging, at discharging. The negative electrode active material is, for example, a carbon material such as graphite or hard carbon, or the like. The negative electrode active material layer 22b may further contain a thickener (for example, carboxymethyl cellulose and a salt thereof, or the like), a binder (for example, styrene butadiene rubber or the like), or the like.

The separator sheets 31 and 32 may have a known structure. For example, the separator sheets 31 and 32 employ a resin porous sheet (film). Examples of resin constituting the resin porous sheet include polyethylene (PE), polypropylene (PP), and the like. The resin porous sheet may have either a single-layer structure or a multilayer structure including two or more layers. The separator sheets 31 and 32 may have a heat resistance layer (HRL) provided on their surfaces.

Here, the negative electrode active material layer 22b is wider than the positive electrode active material layer 21b, for example. The separator sheets 31 and 32 are wider than the negative electrode active material layer 22b. The active material layer non-formation part 21al of the positive electrode current collection foil 21a and the active material layer non-formation part 22al of the negative electrode current collection foil 22a are formed on sides opposite to each other in the width direction. The positive electrode sheet 21, the first separator sheet 31, the negative electrode sheet 22, and the second separator sheet 32 are aligned in a length direction, stacked in order and wound. The negative electrode active material layer 22b covers the positive electrode active material layer 21b with the separator sheets 31 and 32 therebetween. The negative electrode active material layer 22b is covered with the separator sheets 31 and 32. The active material layer non-formation part 21al of the positive electrode current collection foil 21a protrudes to one side of the separator sheets 31 and 32 in the width direction. The active material layer non-formation part 22al of the negative electrode current collection foil 22a protrudes from the separator sheets 31 and 32 on the other side in the width direction.

As illustrated in FIG. 1, the electrode body 20 described above is in a flat state along one plane including a winding axis so that the electrode body 20 can be accommodated in an exterior can 41a of the battery case 41. Along the winding axis of the electrode body 20, the active material layer non-formation part 21al of the positive electrode current collection foil 21a is disposed on one side and the active material layer non-formation part 22al of the negative electrode current collection foil 22a is disposed on the other side. The active material layer non-formation part 21al of the positive electrode current collection foil 21a and the active material layer non-formation part 22al of the negative electrode current collection foil 22a are attached to the internal terminals 42 attached to both side parts of a sealing plate 41b in a longitudinal direction thereof. The electrode body 20 is accommodated in the battery case 41 while the electrode body 20 is attached to the internal terminals 42 attached to the sealing plate 41b in this manner. Therefore, the electrode body 20 is a wound electrode body in the illustrated example. The electrode body 20 is, however, not limited to this example and may alternatively be a stacked-type electrode body in which a plurality of positive electrode sheets and a plurality of negative electrode sheets are stacked alternately with the separator between each positive electrode sheet and each negative electrode sheet.

### <Battery Case 41>

As illustrated in FIG. 1 and FIG. 2, in this embodiment, the battery case 41 includes the exterior can 41a and the sealing plate 41b. The battery case 41 is made of aluminum (for example, 1000-series aluminum) or an aluminum alloy (for example, 3000-series aluminum), and is particularly made of aluminum. The exterior can 41a includes the opening part. Specifically, the exterior can 41a has a container shape with a flat and substantially rectangular cuboid shape and one plane of the exterior can 41a formed by long sides and short sides is open. The sealing plate 41b is a plate-shaped member having a shape corresponding to the opening part of the exterior can 41a. The sealing plate 41b seals the opening part of the exterior can 41a. In both side parts of the sealing plate 41b in a longitudinal direction thereof, terminal attachment holes 41c for attaching the internal terminals 42 and the external terminals 43 to each other are formed. Here, the terminal attachment holes 41c are formed at the sealing plate 41b.

### <Internal Terminal 42>

The internal terminal 42 is disposed with a space from the battery case 41 on the inside of the battery case 41 as illustrated in FIG. 1 and FIG. 2. In this embodiment, the internal terminal 42 is a plate-shaped member as illustrated in FIG. 2. The internal terminal 42 is disposed inside the battery case 41 with a space from the sealing plate 41b where the terminal attachment hole 41c is provided. The internal terminal 42 includes a base part 42a, a current collection part 42b, and a protrusion part 42c. The base part 42a is a portion extending along the sealing plate 41b of the battery case 41. The current collection part 42b is a portion extending from one end of the base part 42a along one side of the electrode body 20 in a winding axis direction. The protrusion part 42c is a portion that is provided at the base part 42a and enters the terminal attachment hole 41c of the sealing plate 41b. The protrusion part 42c has a depression provided from the inside of the base part 42a and protrudes to the outside. The protrusion part 42c has a flat surface 42cl at a tip end thereof. The internal terminal 42 is made of, for example, aluminum on the positive electrode side and copper on the negative electrode side.

### <External Terminal 43>

The external terminal 43 is a member that is disposed outside the battery case 41 with a space from the battery case 41 and is connected to the internal terminal 42 through the terminal attachment hole 41c. In this embodiment, as illustrated in FIG. 2, the external terminal 43 is a member with a flat plate shape, and is disposed with a space from the sealing plate 41b where the terminal attachment hole 41c is provided. The external terminal 43 is overlapped on the flat surface 42cl of the protrusion part 42c of the internal terminal 42 that has entered the terminal attachment hole 41c, and this part is joined. In this manner, the internal terminal 42 is the plate-shaped member in this embodiment. The base part 42a of the internal terminal 42 includes the protrusion part 42c, which has a depression provided from the inside, enters the terminal attachment hole 41c, and has its tip end being flat. The flat part at the tip end of the protrusion part 42c (flat surface 42c1) is joined to the external terminal 43. The external terminal 43 is made of, for example, aluminum on the positive electrode side and copper on the negative electrode side.

The joining between the internal terminal 42 and the external terminal 43 may be, for example, solid-phase joining. By the solid-phase joining, the electrical resistance of a joining part 45 where the internal terminal 42 and the external terminal 43 are joined can be suppressed to be low. The solid-phase joining employs, for example, ultrasonic joining. In the ultrasonic joining, the internal terminal 42 and the external terminal 43 are overlapped on each other and held by a horn and an anvil and then the horn is vibrated. Thus, the internal terminal 42 and the external terminal 43 that are overlapped are heated and softened in the solid-phase (solid) state without being melted, and by further applying pressure to cause the plastic deformation, the internal terminal 42 and the external terminal 43 are joined together. The joining method by the solid-phase joining can employ, in addition to the ultrasonic joining, cold welding, hot welding, friction welding, or the like. It should be noted that the joining between the internal terminal 42 and the external terminal 43 can employ various methods without being limited to those given above. For example, the internal terminal 42 and the external terminal 43 may be welded.

In at least a part of portions of the battery case 41 (in this embodiment, the sealing plate 41b), the internal terminal 42, and the external terminal 43 to which the insulating resin member 44 is joined (that is, portions where the insulating resin member 44 is in contact with the battery case 41, the internal terminal 42, and the external terminal 43), a rough surface with an arithmetic average roughness of 30 nm to 500 nm may be formed. Here, on the rough surface to be formed in the portion where the resin is joined, minute concavo-convexity may be formed by a roughening process such as laser irradiation or a chemical etching process. By the formation of the rough surface in the portion where the insulating resin member 44 is joined, the joining strength between the insulating resin member 44, and the battery case 41 (in this embodiment, the sealing plate 41b), the internal terminal 42, and the external terminal 43 is improved. From the viewpoint of improving the joining strength of the insulating resin member 44, the arithmetic average roughness of the concavo-convexity in the roughening process may be about 30 nm to 500 nm. The arithmetic average roughness of the concavo-convexity in the roughening process is desirably 450 nm or less and more desirably 400 nm or less. On the other hand, the arithmetic average roughness of the concavo-convexity in the roughening process is desirably 40 nm or more and more desirably 50 nm or more. In another example of the member made of copper, the arithmetic average roughness may be about 60 nm to 240 nm. In the member made of aluminum, the arithmetic average roughness may be about 48 nm to 435 nm. The process for roughening the portion where the insulating resin member 44 is joined in this manner can also be called a nano-anchor process.

### <Insulating Resin Member 44>

The insulating resin member 44 is disposed so as to fill the space between the battery case 41 and the internal terminal 42 and between the battery case 41 and the external terminal 43. The insulating resin member 44 is joined to the battery case 41, the internal terminal 42, and the external terminal 43. By the insulating resin member 44, the battery case 41 and the internal terminal 42 are insulated from each other and the battery case 41 and the external terminal 43 are insulated from each other. In this embodiment, the insulating resin member 44 is typically formed by insert molding.

The insulating resin constituting the insulating resin member 44 contains polyphenylene sulfide (PPS) and a glass filler. PPS is superior in heat resistance, chemical resistance, self-extinguishability, and the like. As described above, in the case of forming the insulating resin member 44 by insert molding using PPS, the present inventor's examination has revealed that the problem of a molding defect can occur. With this regard, in the case where the insulating resin constituting the insulating resin member 44 contains the glass filler in addition to PPS as described in this embodiment, the linear expansion coefficient of the sealing plate made of aluminum becomes close to that of the insulating resin used in the insert molding; thus, the molding defect can be reduced.

The amount of glass filler contained in the insulating resin constituting the insulating resin member 44 is not limited in particular as long as the effect of the present disclosure can be obtained. The electrode terminals of the battery 10 (that is, the internal terminals 42 and the external terminals 43) are typically formed of different materials in the positive electrode and the negative electrode. For example, the electrode terminal on the positive electrode side is made of aluminum (Al) and the electrode terminal on the negative electrode side is made of copper (Cu). In the case where the difference in thermal expansion between the insulating resin and metal constituting the terminals is small, the stress caused at cooling and heating can be reduced and the durability against thermal shock can be improved. Therefore, it is desirable to adjust the linear expansion coefficient of the insulating resin so as to become intermediate between the linear expansion coefficients of the metal (for example, Al) constituting the electrode terminal on the positive electrode side and the material (for example, Cu) constituting the electrode terminal on the negative electrode side. However, if the amount of glass filler in the insulating resin is too large, the moldability deteriorates. Accordingly, the amount of glass filler in the insulating resin constituting the insulating resin member 44 is desirably 40 mass % to 60 mass %.

The insulating resin constituting the insulating resin member 44 may contain other component (for example, additive or the like) than PPS and the glass filler.

In the mode illustrated in FIG. 2, at the joining part 45 between the internal terminal 42 and the external terminal 43, an inner surface of the internal terminal 42 that faces the inside of the battery case 41 is covered with the insulating resin member 44. Therefore, a part 44a of the insulating resin member 44 that covers the joining part 45 prevents the joining part 45 from being exposed to the nonaqueous electrolyte solution or the atmosphere in the battery case 41. Accordingly, the deterioration of the joining part 45 is suppressed. However, a part (for example, the part 44a) of the insulating resin member 44 that is disposed on the inner surface of the internal terminal 42 exists inside the battery case 41 and at a position that can be in contact with the nonaqueous electrolyte solution. In addition, an end part of the part of the insulating resin member 44 that is between the sealing plate 41b and the internal terminal 42 also exists inside the battery case 41 and at the position that can be in contact with the nonaqueous electrolyte solution.

At least a part of the insulating resin member 44 may be in contact with the electrode body 20. In the mode illustrated in FIG. 2, the insulating resin member 44 includes, in a part of the insulating resin member 44 that covers the inner surface of the internal terminal 42, a contact part 44b that bulges to the inside of the battery case 41. With this contact part 44b, the electrode body 20 attached to the internal terminal 42 is pressed. Thus, the electrode body 20 becomes stable inside the battery case 41. It should be noted that the contact part 44b also exists inside the battery case 41 and at the position that can be in contact with the nonaqueous electrolyte solution.

In this embodiment, the electrode body 20 is attached to the current collection part 42b of the internal terminal 42 that is fixed to the sealing plate 41b through the insulating resin member 44. Accordingly, an assembly in which the electrode body 20 is attached to the internal terminal 42 fixed to the sealing plate 41b is prepared. In this assembly, the electrode body 20 is accommodated in the exterior can 41a.

In this embodiment, the insulating resin member 44 surrounds an outer periphery of the external terminal 43. This makes it difficult for the external terminal 43 to be displaced with respect to the sealing plate 41b. In view of this, the insulating resin member 44 may include a restriction part 44c that restricts the outer periphery of the external terminal 43. In this embodiment, the restriction part 44c rises along the outer periphery of the external terminal 43 and surrounds the entire outer periphery of the external terminal 43. The restriction part 44c may restrict the outer periphery of the external terminal 43 partially in a circumferential direction.

In the battery 10, the portions where the internal terminal 42 and the external terminal 43 are attached to the battery case 41 are covered with the insulating resin member 44. Therefore, the stress that acts on the joining parts between the battery case 41, and the internal terminal 42 and the external terminal 43 is received by the entire insulating resin member 44. Accordingly, the defect in a leak test of the battery case 41 and the defect in a resistance test are reduced and the yield is improved. The number of components in the portions where the internal terminal 42 and the external terminal 43 are attached to the battery case 41 is reduced.

It should be noted that the structure in which the insulating resin member 44 is disposed between the sealing plate 41b and the electrode terminal in the battery 10 (this structure is hereinafter also referred to as “electrode terminal structure”) is not limited to the illustrated structure as long as a part of the insulating resin member 44 is at the position that can be in contact with the nonaqueous electrolyte solution inside the battery case 41. Another embodiment will hereinafter be described as a modification of the electrode terminal structure.

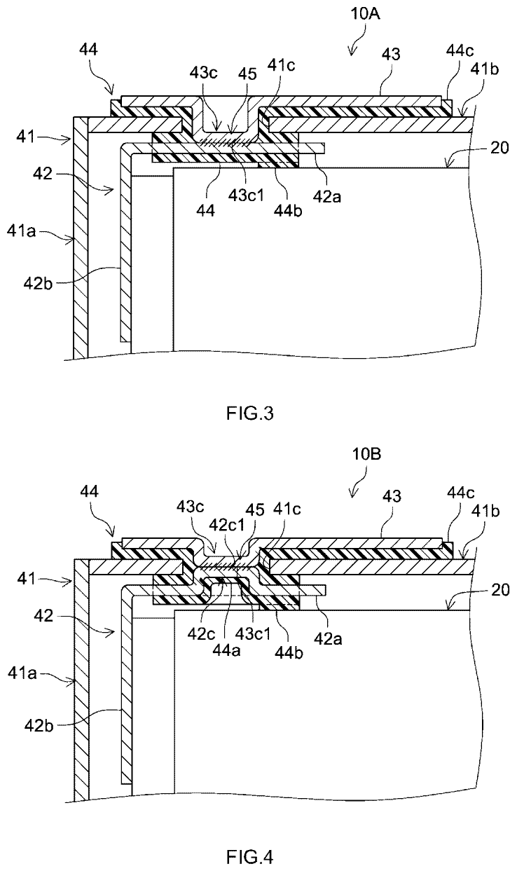

For example, FIG. 3 is a partial cross-sectional view of a battery 10A according to another embodiment. FIG. 3 is a cross-sectional view in a direction parallel to a wide surface of the battery case 41. As illustrated in FIG. 3, the external terminal 43 of the battery 10A is a plate-shaped member, and includes a protrusion part 43c, which has a depression provided from the outside, enters the terminal attachment hole 41c, and has its tip end being flat. On the other hand, the base part 42a of the internal terminal 42 is formed to have a flat plate shape. A part 43c1, which is flat at the tip end of the protrusion part 43c, is overlapped on and joined to the internal terminal 42. In the mode illustrated in FIG. 3, the inner surface of the internal terminal 42 is covered with the insulating resin member 44. In particular, the insulating resin member 44 includes the part 44a that covers the joining part 45 between the internal terminal 42 and the external terminal 43 inside the battery case 41. In addition, the contact part 44b that bulges to the inside of the battery case 41 and is in contact with the electrode body 20 is provided as a part of the insulating resin member 44. In this embodiment, also, a part of the insulating resin member 44 (for example, a part that is disposed at the inner surface of the internal terminal 42 or the like) exists inside the battery case 41 and at the position that can be in contact with the nonaqueous electrolyte solution.

FIG. 4 is a partial cross-sectional view of a battery 10B according to yet another embodiment. FIG. 4 is a cross-sectional view in the direction parallel to the wide surface of the battery case 41. As illustrated in FIG. 4, the internal terminal 42 of the battery 10B is a plate-shaped member, and includes the protrusion part 42c, which has a depression provided from the inside, protrudes toward the terminal attachment hole 41c, and has its tip end being flat. The external terminal 43 is a plate-shaped member, and includes the protrusion part 43c, which has a depression provided from the outside, protrudes toward the terminal attachment hole 41c, and has its tip end being flat. Moreover, the flat part 42c1, which is flat at the tip end of the protrusion part 42c of the internal terminal 42, and the part 43c1, which is the flat part of the protrusion part 43c of the external terminal 43, are joined together. In the mode illustrated in FIG. 4, the inner surface of the internal terminal 42 is covered with the insulating resin member 44. In particular, the insulating resin member 44 includes the part 44a that covers the joining part 45 between the internal terminal 42 and the external terminal 43 inside the battery case 41. In addition, the contact part 44b that bulges to the inside of the battery case 41 and is in contact with the electrode body 20 is provided as a part of the insulating resin member 44. In this embodiment, also, a part of the insulating resin member 44 (for example, a part that is disposed at the inner surface of the internal terminal 42 or the like) exists inside the battery case 41 and at the position that can be in contact with the nonaqueous electrolyte solution.

FIG. 5 is a partial cross-sectional view of a battery 10C according to still yet another embodiment. FIG. 5 is a cross-sectional view in a direction perpendicular to the wide surface of the battery case 41, and in this point, FIG. 5 is different from FIG. 3 and FIG. 4. In this embodiment, an electrode terminal 46 is used instead of the internal terminal 42 and the external terminal 43. The electrode terminal 46 plays a role of both the internal terminal 42 and the external terminal 43. The electrode terminal 46 of the battery 10C penetrates the terminal attachment hole 41c of the sealing plate 41b and protrudes from the inside of the battery case 41 to the outside. The electrode terminal 46 has its tip end bent. The insulating resin member 44 is disposed so as to fill the terminal attachment hole 41c around the electrode terminal 46. The insulating resin member 44 is disposed also between the electrode terminal 46 and the sealing plate 41b. The insulating resin member 44 is additionally disposed on the inner side of the sealing plate 41b. In this embodiment, moreover, a part of the insulating resin member 44 (for example, a part that is disposed on the inner surface of the sealing plate 41b or the like) exists inside the battery case 41 and at the position that can be in contact with the nonaqueous electrolyte solution.

### <Manufacturing Method for Electrode Terminal Structure>

Regarding a manufacturing method for the structure in which the insulating resin member 44 is disposed between the sealing plate 41b and the electrode terminal (electrode terminal structure), the structure of the battery 10A (see FIG. 3) will be described as an example. In the following example, the insert molding method is employed. However, the manufacturing method for the electrode terminal structure is not limited to the following method.

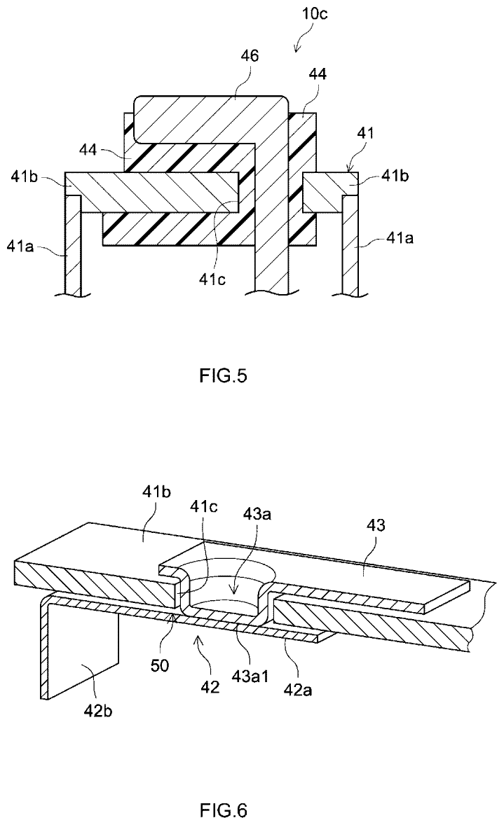

As illustrated in FIG. 6, first, the sealing plate 41b, the internal terminal 42, and the external terminal 43 are prepared. These members may be subjected to the roughening process by the laser irradiation or the chemical etching process. In the illustrated example, the sealing plate 41b is the plate-shaped member. In the sealing plate 41b, the terminal attachment hole 41c with a predetermined size is provided at a predetermined position. The external terminal 43 includes the protrusion part 43c that enters the terminal attachment hole 41c. On the other hand, the base part 42a of the internal terminal 42 is formed to have a flat plate shape.

As illustrated in FIG. 6, the part 43c1, which is flat at the tip end of the protrusion part 43c of the external terminal 43, is overlapped on and joined to the internal terminal 42 in the terminal attachment hole 41c of the sealing plate 41b. This joining can employ the solid-phase joining such as ultrasonic joining, or welding as described above.

The sealing plate 41b, the internal terminal 42, and the external terminal 43 are disposed in a mold (not illustrated) so that a gap 50 (see FIG. 6) is formed between the internal terminal 42 and the external terminal 43, and the sealing plate 41b. In this mold, wall surfaces that define a region (that is, cavity space) to be filled with the insulating resin member 44 are provided. In addition, in this mold, a spool, a runner, a gate, or the like to fill the cavity space with the insulating resin is provided.

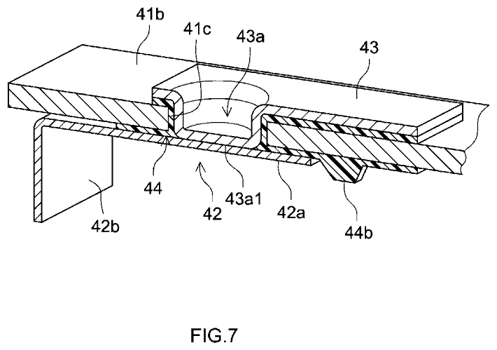

On the other hand, the insulating resin containing PPS and the glass filler is prepared. This insulating resin is heated at or above the melting point of PPS and thereafter is injected into the mold. Thus, the cavity space is filled with the insulating resin. After that, the insulating resin is cooled in the mold; thus, the insulating resin member 44 is insert-molded. Accordingly, as illustrated in FIG. 7, the internal terminal 42 and the external terminal 43, and the sealing plate 41b are joined together by the insulating resin member 44. It should be noted that in the case where the sealing plate 41b, and the internal terminal 42 and the external terminal 43 are subjected to the roughening process, the insulating resin member 44 enters the minute concavo-convexity, so that the anchor effect is obtained and the internal terminal 42 and the external terminal 43, and the sealing plate 41b are joined together more firmly by the insulating resin member 44.

### <Nonaqueous Electrolyte Solution>

In this embodiment, the nonaqueous electrolyte solution contains a dehydrating agent. In addition, the nonaqueous electrolyte solution typically contains a nonaqueous solvent and a supporting salt (electrolyte salt).

As described above, according to the present inventor's examination, in the case of forming the insulating resin member containing PPS and the glass filler, it has been newly found out that this glass filler can corrode, which is a problem. The present inventor's further examination indicates that this corrosion occurs due to the following reason. That is to say, a part of the insulating resin member 44 exists at the position that can be in contact with the nonaqueous electrolyte solution inside the battery case 41. In a case where hydrogen fluoride (HF) is generated in the nonaqueous electrolyte solution due to side reaction or the like, the contact of this hydrogen fluoride with the insulating resin member 44 causes corrosion of SiO₂ contained in the glass filler as expressed by the following reaction formula (1). Along with this, water is generated and a hydrolysis reaction of lithium hexafluorophosphate (LiPF₆) included in the electrolyte solution occurs as expressed by the following reaction formula (2). At this time, another hydrogen fluoride is generated and accordingly, the glass filler is further corroded. Therefore, due to the chained corrosion of the glass filler, the insulating resin member deteriorates.

SiO₂+4HF→SiF₄+2H₂O (1)

LiPF₆+4H₂O→LiF+5HF+H₃PO₄ (2)

In view of this, by adding the dehydrating agent to the nonaqueous electrolyte solution, the reaction expressed by the above reaction formula (2) can be suppressed and the deterioration of the insulating resin member 44 due to the chained corrosion of the glass filler can be suppressed.

The dehydrating agent may be either a material that adsorbs water or a compound that reacts with water to consume the water. Examples of the dehydrating agent include a molecular sieve, sodium sulfate, silica gel, magnesium oxide, calcium oxide, calcium chloride, calcium hydride, potassium hydride, sodium hydride, lithium aluminum hydride, and anhydrides (such as succinic anhydride, glutaric anhydride, and maleic anhydride), and the like.

The amount of dehydrating agent in the nonaqueous electrolyte solution may be selected as appropriate in accordance with the kind. The amount of dehydrating agent in the nonaqueous electrolyte solution may be, for example, 0.1 mass % to 20 mass %, 0.5 mass % to 10 mass %, or 1 mass % to 5 mass %.

As the nonaqueous solvent, various organic solvents used for the electrolyte solution of the general lithium ion secondary batteries, such as carbonates, ethers, esters, nitriles, sulfones, and lactones, can be used without particular limitations. In particular, the carbonates are desirable and specific examples thereof include ethylene carbonate (EC), propylene carbonate (PC), diethyl carbonate (DEC), dimethyl carbonate (DMC), ethyl methyl carbonate (EMC), monofluoroethylene carbonate (MFEC), and the like. As the nonaqueous solvent described above, one kind can be used alone or two or more kinds thereof can be used in combination as appropriate.

Desired examples of the supporting salt include lithium salts such as LiPF₆ and lithium bis(fluorosulfonyl)imide (LiFSI). The concentration of the supporting salt is desirably 0.7 mol/L or more and 1.3 mol/L or less.

The nonaqueous electrolyte solution may contain a component other than the aforementioned components unless the effect of the present disclosure is impaired remarkably. Examples of such a component include various additives including a film formation agent such as vinylene carbonate (VC) or an oxalato complex; a gas generator such as biphenyl (BP) or cyclohexyl benzene (CHB); a thickener; and the like.

The battery 10 can be used in various applications. Specific applications include a portable power source for a personal computer, a mobile electronic appliance, a mobile terminal, or the like; a power source for driving a vehicle such as a battery electric vehicle (BEV), a hybrid electric vehicle (HEV), or a plug-in hybrid electric vehicle (PHEV); a storage battery of a small electrical energy storage device; and the like. In particular, the power source for driving a vehicle is desirable. The battery 10 can also be used in a form of a battery pack in which a plurality of the batteries 10 are connected to each other in series and/or in parallel typically.

The specific examples of the present disclosure have been described above in detail; however, these are merely examples and will not limit the scope of claims. The techniques described in the scope of claims include those in which the specific examples exemplified above are variously modified and changed.

That is to say, the following Items [1] to [9] are given as the nonaqueous electrolyte secondary battery disclosed herein.
[1] The nonaqueous electrolyte secondary battery including: the electrode body; the nonaqueous electrolyte solution; the electrode terminal; and the battery case that accommodates the electrode body and the nonaqueous electrolyte solution, in which the battery case is made of aluminum or an aluminum alloy, the battery case includes the exterior can that includes the opening part, and the sealing plate that seals the opening part, the electrode terminal is insulated from the sealing plate by the insulating resin member, the insulating resin member contains polyphenylene sulfide and the glass filler, the insulating resin member exists at least partially inside the battery case and at the position that can be in contact with the nonaqueous electrolyte solution, and the nonaqueous electrolyte solution contains the dehydrating agent as the additive.
[2] The nonaqueous electrolyte secondary battery according to Item [1], in which the insulating resin member is integrated with the sealing plate and the electrode terminal by the insert molding.
[3] The nonaqueous electrolyte secondary battery according to Item [1] or [2], in which the content of the glass filler in the insulating resin constituting the insulating resin member is 40 mass % to 60 mass %.
[4] The nonaqueous electrolyte secondary battery according to any one of Items [1] to [3], in which the rough surface with an arithmetic average roughness of 30 nm to 500 nm is formed at least partially in the part where the insulating resin member is in contact with the battery case and the electrode terminal.
[5] The nonaqueous electrolyte secondary battery according to any one of Items [1] to [4], in which the dehydrating agent is the material that adsorbs water.
[6] The nonaqueous electrolyte secondary battery according to any one of Items [1] to [4], in which the dehydrating agent is the compound that reacts with water to consume the water.
[7] The nonaqueous electrolyte secondary battery according to any one of Items [1] to [6], in which the nonaqueous electrolyte secondary battery is the lithium ion secondary battery.

What is claimed is:

1. A nonaqueous electrolyte secondary battery comprising:
an electrode body;
a nonaqueous electrolyte solution;
an electrode terminal; and
a battery case that accommodates the electrode body and the nonaqueous electrolyte solution, wherein
the battery case is made of aluminum or an aluminum alloy,
the battery case includes an exterior can that includes an opening part, and a sealing plate that seals the opening part,
the electrode terminal is insulated from the sealing plate by an insulating resin member,
the insulating resin member contains polyphenylene sulfide and a glass filler,
the insulating resin member exists at least partially inside the battery case and at a position that can be in contact with the nonaqueous electrolyte solution, and
the nonaqueous electrolyte solution contains a dehydrating agent as an additive.

2. The nonaqueous electrolyte secondary battery according to claim 1, wherein the insulating resin member is integrated with the sealing plate and the electrode terminal by insert molding.

3. The nonaqueous electrolyte secondary battery according to claim 1, wherein a content of the glass filler in the insulating resin constituting the insulating resin member is 40 mass % to 60 mass %.

4. The nonaqueous electrolyte secondary battery according to claim 1, wherein a rough surface with an arithmetic average roughness of 30 nm to 500 nm is formed at least partially in a part where the insulating resin member is in contact with the battery case and the electrode terminal.

5. The nonaqueous electrolyte secondary battery according to claim 1, wherein the dehydrating agent is a material that adsorbs water.

6. The nonaqueous electrolyte secondary battery according to claim 1, wherein the dehydrating agent is a compound that reacts with water to consume the water.

7. The nonaqueous electrolyte secondary battery according to claim 1, wherein the nonaqueous electrolyte secondary battery is a lithium ion secondary battery.
